(19) United States
(12) Patent Application Publication
(10) Pub. No.: US 2023/0167822 A1
(43) Pub. Date: Jun. 1, 2023

(54) VACUUM SYSTEM HAVING CONDENSER AND ROOT VACUUM PUMP SET

(71) Applicants: Raymond Zhou Shaw, Shanghai (CN); JIAN WEI ZHANG, Shanghai (CN); Xiaoqing Pan, Shanghai (CN)

(72) Inventors: Raymond Zhou Shaw, Shanghai (CN); JIAN WEI ZHANG, Shanghai (CN); Xiaoqing Pan, Shanghai (CN)

(21) Appl. No.: 18/161,906

(22) Filed: Jan. 31, 2023

Related U.S. Application Data
(63) Continuation-in-part of application No. 17/485,532, filed on Sep. 27, 2021.

(51) Int. Cl. F04C 18/12; F04C 25/02; F04C 23/00; H02K 9/04

(52) U.S. Cl. CPC F04C 18/126; F04C 25/02; F04C 23/001; H02K 9/04; F04C 2210/221; F04C 2220/10; F28B 11/00

(57) ABSTRACT

A vacuum system having a condenser and a root vacuum pump set includes an independent inlet condenser set having an inlet end for receiving vapor inputted from an output of an air cooling power generator condenser of a generator; air in the vapor being condensed, and the surplus air is outputted; a root vacuum pump set including a plurality of root vacuum pumps; the root vacuum pump set further including an input end and an output end; the input end being connected to the independent inlet condenser set; air outputted from the independent inlet condenser set being inputted to the plurality of root vacuum pump for compression and then the compressed air being outputted from the output end; and a backing pump connected to the output end of the root vacuum pump set by using an output pipe; the backing pump serving to receive air outputted from the root vacuum pump set.

The invention is a continuation in part (CIP) of the U.S. Patent application Ser. No. 17/485,532 filed at Sep. 27, 2021, invented and assigned to the inventor of the present invention, and thus the contents of the U.S. patent application Ser. No. 17/485,532 is incorporated into the present invention as a part of the specification.

### FIELD OF THE INVENTION

The present invention is related to root pumps, and in particular to a vacuum system having a condenser and a root vacuum pump set

### BACKGROUND OF THE INVENTION

Currently, for power generators used in power plants, the power generator sets are divided as water cooling generator sets and air cooling condenser of the generator sets. The types of air cooling power generator sets may be classified into direct air cooling form and indirect air cooling form. A direct air cooling condenser of the generator set has a condenser. On contrast, an indirect air cooling condenser of the generator set has no condenser. An air cooling condenser of the generator is required to be operated under a vacuum state, so maintaining a vacuum system to generate a vacuum state is necessary. The vacuum maintaining system of an air cooling power generator usually uses a liquid circulating vacuum pump system which can be used to maintain a vacuum state.

The prior technology for a liquid circulating vacuum pump system of an air cooling power generator condenser sets mainly uses a single liquid circulating vacuum pump system. However, using above technology consumes large amounts of electric powers and water. The volume of liquid circulating vacuum pump system is large and occupies a big space. Furthermore, the liquid circulating vacuum pump systems generate greater noises and need expensive maintaining costs, so using liquid circulating vacuum pump leads to a large space occupation and higher costs.

Most of power plants use liquid circulating vacuum pumps to improve the vacuum level. The capabilities of drawing air decline, while air etching occurs. Especially in summer, the liquid circulating vacuum pump is easier to be eroded to cause that the capability of drawing air declines rapidly especially, when the temperature is high. Therefore, the vacuum state of air cooling condenser sets becomes worse, and the efficiency of steam turbine is low, so that the coal consumption increases.

The present invention provides a new vacuum system based on a self equipped up front installed condenser set and a multiple stage special custom made roots pumps and liquid ring vacuum system to solve the defects mentioned above.

### SUMMARY OF THE INVENTION

Accordingly, the object of the present invention is to provide a vacuum system having an independent condenser set and a root vacuum pump set, wherein the independent inlet condenser set, the root vacuum pump set and the backing pump are formed as a vacuum system which is used as vacuum maintaining system for an air cooling power generator set. In the structure of the present invention, the power and water consumptions of the air cooling power generator system are greatly reduced. The condensed water is reused by using the liquid collecting and recycling tank unit. Therefore, the system of the present invention not only reduces the power consumption, but also reduces the whole maintaining cost. Furthermore the objects of reduction of water usage and environmental protections are achieved.

To achieve above object, the present invention provides a vacuum system having an independent inlet condenser set and a root vacuum pump set, comprising: an independent inlet condenser set having an inlet end for receiving vapor inputted from an output of an air cooling power generator condenser of a generator; the output vapor which is mixture of non-condensable air and water steam; the water steam capable to be condensed, and the surplus air being outputted; a root vacuum pump set including a plurality of root vacuum pumps; the root vacuum pump set further including an input end and an output end; the input end being connected to the independent inlet condenser set; air outputted from the independent inlet condenser set being inputted to the plurality of root vacuum pumps for compression and then the compressed air being outputted from the output end and a backing pump connected to the output end of the root vacuum pump set by using an output pipe; the backing pump serving to receive air outputted from the root vacuum pump set.

### BRIEF DESCRIPTION OF THE DRAWINGS

FIG. 1 is a schematic view showing the assembly of the elements of the present invention.

FIG. 2 is a schematic view showing another assembly of the elements of the present invention.

FIG. 3 is a schematic view showing a further assembly of the elements of the present invention.

FIG. 4 is a schematic cross section view of the root vacuum pump of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

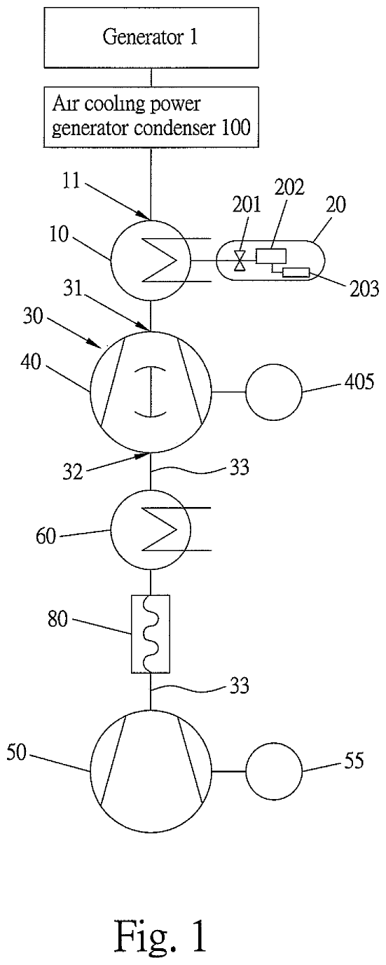

With reference to FIGS. 1 to 3, the structure of the present invention is illustrated. The present invention includes the following elements.

An independent inlet condenser set 10 has an inlet end 11 for receiving vapor inputted from an output of an air cooling power generator condenser 100 of a generator 1. The output vapor of the air cooling power generator condenser 100 is mixture of non-condensable air and water steam. The water steam in the output vapor is capable to be condensed by the independent inlet condenser set 10 and the volume thereof is reduced for reducing the air amount inputted to the succeeding elements. In this way, the vacuum system is as if enlarged. The air pressure in the inlet end 11 of the independent inlet condenser set 10 can be as larger as 10000˜25000 Pa (Pascal), although higher vacuum level or lower pressure is more favorable. The independent inlet condenser set 10 may be condensers of any form.

The independent inlet condenser set 10 is connected to a liquid collecting and recycling tank unit 20 for collecting condensed liquid (such as soft water) from the independent inlet condenser set 10, in that the soft water from the air cooling power generator condenser 100. The liquid collecting and recycling tank unit 20 has an automatic double valve set up device 201 and a water level gauge 202 that is connected to a controller 203. The controller 203 has DCS (Distributed Control System) or PLC (Programmable Logic Control) (not show). Therefore, the liquid collecting and recycling tank unit 20 is capable to recycle soft water automatically and continuously without interrupting the vacuum system working. The condensed liquid and soft water can be reused.

A root vacuum pump set 30 includes at least one root vacuum pump 40. The root vacuum pump set 30 further includes an input end 31 and an output end 32. The input end 31 is connected to the independent inlet condenser set 10. Air outputted from the independent inlet condenser set 10 is inputted to the at least one root vacuum pump 40 for compression and then the compressed air is outputted from the output end 32. Any of the root vacuum pump 40 may be any kind of root vacuum pump, preferably, it can suffer from pressure greater than one or several tens of thousands Pa, for example, two blade root vacuum pump, three blade root vacuum pumps, air cooling root vacuum pump, or cascade root vacuum pump, etc.

Each root vacuum pump 40 is connected to an electric driving device 405 for driving a respective root vacuum pump 40.

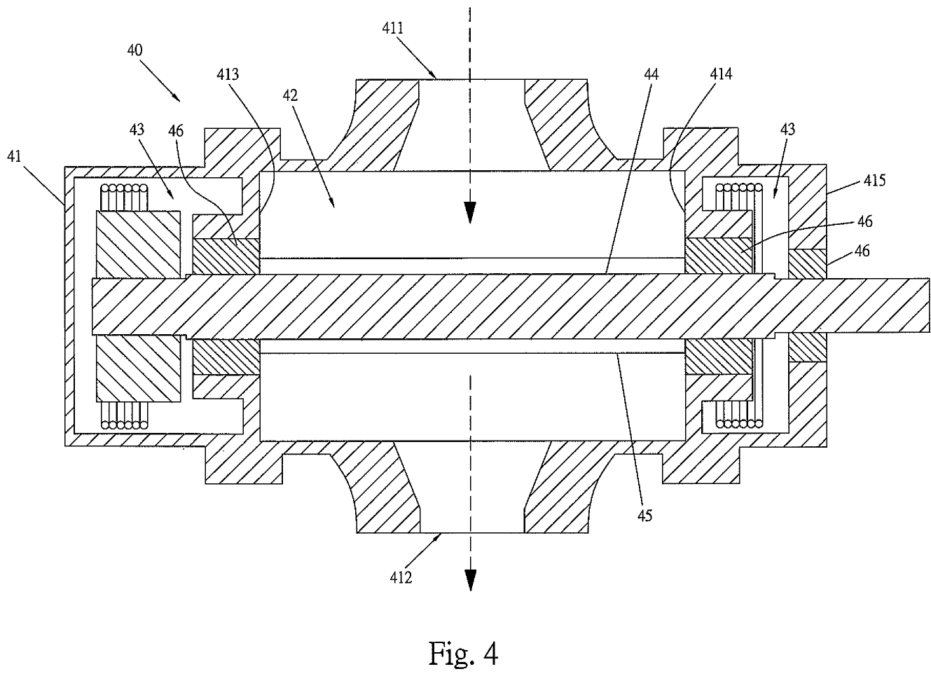

Referring to FIG. 4, each said root vacuum pump 40 has a casing 41 which has an inlet 411 and an outlet 412. An interior of the casing 41 is formed with a vacuum chamber 42 and two bearing rooms 43 at two sides of the vacuum chamber 42. The vacuum chamber 42 is connected and communicated to the inlet 411 and the outlet 412. A driving shaft 44 is installed within the casing 41 and penetrates through the vacuum chamber 42 and the two bearing rooms 43. One end of the driving shaft 44 passes out of a right wall 415 of the casing 41. A blade set 45 is installed within the vacuum chamber 42 and is installed on the driving shaft 44. The gas mixture is inputted from the inlet 411 to the vacuum chamber 42. By rotation of the blade set 45, the gas mixture is compressed and is outputted from the outlet 412.

Inner connection walls 413, 414 between the vacuum chamber 42 and the two bearing rooms 43 are installed with respective bearings 46 which are arranged to be around the driving shaft 44; as well as an opening of the right wall 415 of the casing 41 is formed with another bearing 46 around the driving shaft 44. The bearings 46 support the driving shaft 44. The bearings 46 completely seal spaces between the driving shaft 44 and the inner walls of the casing 41 so that the vacuum chamber 42 is completely isolated from the two bearing rooms 43. Therefore, liquid out of the casing 41 and in the two bearing rooms 43 cannot permeate into the vacuum chamber 42. Furthermore, the gas mixture in the vacuum chamber 42 cannot enter into the bearing rooms 43. Therefore, in operation, interior of the vacuum chamber 42 of the root vacuum pump 40 only has original air and the gas mixture without any impurities. Moreover, liquid within the bearing rooms 43 cannot drain out of the casing 41.

In the present invention, the root vacuum pump 40 has a complete sealing structure, which is not half-sealed structure. Therefore, in the present invention, the vacuum chamber 42, the bearing rooms 43 and other related driving structures (such as gears) are completely isolated from liquid so as to avoid of the problems of vapors, emulsions or drainages, etc.

The root vacuum pump 40 has a structure which can suffer a great pressure difference. The great pressure means that the root vacuum pump 40 can operate under an inlet pressure of 5000 Pa to 30000 Pa in a whole day under a condition that the condenser is in a vacuum state and can suffer from a pressure difference larger than 5000 Pa. General prior root vacuum pump cannot work under this condition.

The root vacuum pump 40 is a high temperature tolerance pump, that is, the root vacuum pump 40 can operates under temperatures larger than 130° C. In operation, the gas temperature of the vacuum chamber 42 of the root vacuum pump 40 will achieve to 200° C.

With reference to FIG. 1, the root vacuum pump set 30 maybe has only one root vacuum pump 40.

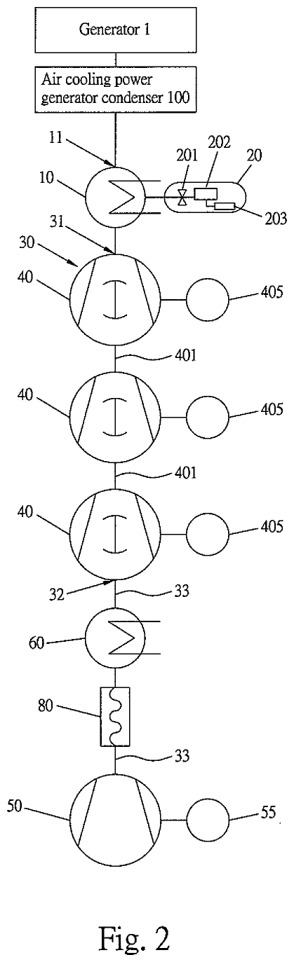

Referring to FIG. 2, the root vacuum pump set 30 includes a plurality of root vacuum pumps 40 which are serially connected. The air outputted from the independent inlet condenser set 10 flows through the plurality of root vacuum pumps 40 sequentially for being compressed several times. Two adjacent root vacuum pumps 40 are connected by an air pipe 401.

The at least root vacuum pump 40 is maybe a root vacuum pump 40 or a plurality of root vacuum pumps 40 for dividing the total pressure so that the whole power in the system is reduced and the water consumed is decreased.

A backing pump 50 is connected to the output end 32 of the root vacuum pump set 30 by using an output pipe 33. The backing pump 50 serves to receive air outputted from the root vacuum pump set 30. The backing pump 50 is a backing pump of any form, preferably, the output air thereof can be drained out to the atmosphere, such as a liquid circulated pump, a vapor jet pump, an atmosphere jet pump or a water flushing pump.

The backing pump 50 can be connected to an electric driving device 55 for driving the backing pump 50.

By the above mentioned structure, the root vacuum pump set 30 serves to compress air from the independent inlet condenser set 10 so as to reduce the volume of the air. Therefore, the air pumped from the backing pump 50 is reduced. When the air pressure of the air from the root vacuum pump 40 of the root vacuum pump set 30 is lower than a predetermined value, the backing pump 50 may be not acted, while the air from the root vacuum pump set 30 directly bypasses through the backing pump 50 to be drained out. Because the backing pump 50 does not act, the power consumed is saved.

A heat exchanger 60 is serially connected to the output pipe 33 for cooling air outputted from the root vacuum pump set 30 and the cooled air is inputted to the backing pump 50. The heat exchanger 60 may be a heat exchanger of any form.

The output pipe 33 is further serially connected to a wave shape pipe 80 so as to retain the preferred sealing effect of the output pipe 33.

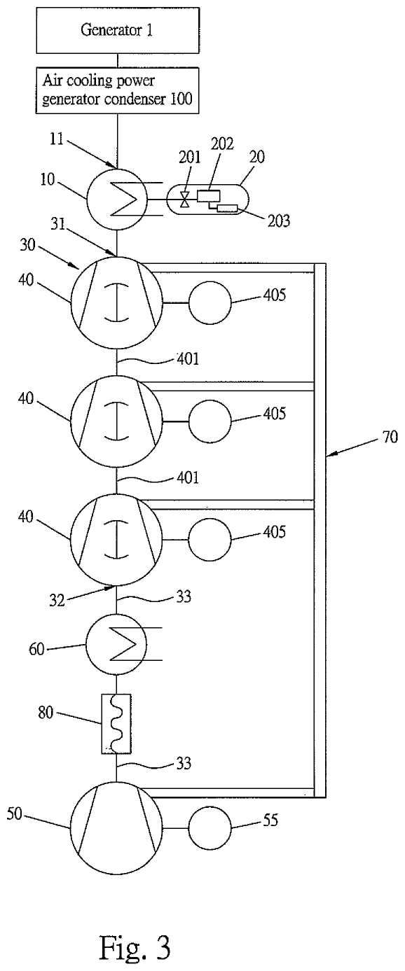

Referring to FIG. 3, the present invention further includes a supporting frame 70 which is connected to the root vacuum pump set 30 and the backing pump 50. The supporting frame 70 serves to support the root vacuum pump set 30 and the backing pump 50. Preferably, the supporting frame 70 includes the steel welding elements.

Advantages of the present invention are that: the independent inlet condenser set, the root vacuum pump set and the backing pump are formed as a vacuum system which is used as vacuum maintaining system for an air cooling power generator set. In the structure of the present invention, the power and water consumptions of the air cooling power generator system is greatly reduced. The condensed water is reused by using the liquid collecting and recycling tank unit. Therefore, the system of the present invention not only reduces the power consumption, but also reduces the whole maintaining cost. Furthermore the objects of reduction of water usage and environmental protections are achieved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vacuum system having an independent inlet condenser set and a root vacuum pump set, comprising:
an independent inlet condenser set (10) having an inlet end (11) for receiving vapor inputted from an output of an air cooling power generator condenser (100) of a generator (1); the output vapor which is mixture of non-condensable air and water steam; the water steam capable to be condensed, and the surplus air being outputted;
a root vacuum pump set (30) including a plurality of root vacuum pumps (40); the root vacuum pump set (30) further including an input end (31) and an output end (32); the input end (31) being connected to the independent inlet condenser set (10); air outputted from the independent inlet condenser set (10) being inputted to the plurality of vacuum pumps (40) for compression and then the compressed air being outputted from the output end (32) and
a backing pump (50) connected to the output end (32) of the root vacuum pump set (30) by using an output pipe (33); the backing pump (50) serving to receive air outputted from the root vacuum pump set (30).

2. The vacuum system having an independent inlet condenser set and a root vacuum pump set as claimed in claim 1, wherein the independent inlet condenser set (10) is connected to a liquid collecting and recycling tank unit (20) for collecting condensed liquid and soft water from the independent inlet condenser set (10), in that, the soft water is from the air cooling power generator condenser (100).

3. The vacuum system having a condenser and a root vacuum pump set as claimed in claim 1, wherein the liquid collecting and recycling tank unit (20) is capable to collect condensed liquid and soft water in vacuum state automatically and continuously.

4. The vacuum system having a condenser and a root vacuum pump set . as claimed in claim 1, wherein the inlet end (11) of the independent inlet condenser set (10) is capable of suffering from a pressure larger than 10000 Pa.

5. The vacuum system having a condenser and a root vacuum pump set as claimed in claim 1, further comprising: a heat exchanger (60) serially connected to the output pipe (33) for cooling air outputted from the root vacuum pump set (30) and the cooled air being inputted to the backing pump (50).

6. The vacuum system having a condenser and a root vacuum pump set as claimed in claim 1, wherein each root vacuum pump (40) is capable of suffering from a pressure larger than 10000 Pa (Pascal).

7. The vacuum system having a condenser and a root vacuum pump set as claimed in claim 1, wherein at least one of the root vacuum pumps (40) is an air cooling root vacuum pump.

8. The vacuum system having a condenser and a root vacuum pump set as claimed in claim 1, wherein each root vacuum pump (40) is connected to an electric driving device (405) for driving a respective root vacuum pump.

9. The vacuum system having a condenser and a root vacuum pump set as claimed in claim 1, wherein the plurality of root vacuum pumps (40) are serially connected; the air outputted from the independent inlet condenser set (10) flows through the plurality of root vacuum pumps (40) sequentially for being compressed several times; and two adjacent root vacuum pumps (40) are connected by an air pipe (401).

10. The vacuum system having a condenser and a root vacuum pump set as claimed in claim 1, wherein output air of the backing pump (50) is drained out to the atmosphere.

11. The vacuum system having a condenser and a root vacuum pump set as claimed in claim 1, wherein the backing pump (50) is a liquid circulated pump.

12. The vacuum system having a condenser and a root vacuum pump set as claimed in claim 1, wherein when the air pressure of the air from the root vacuum pump (40) of the root vacuum pump set (30) is lower than a predetermined value, the backing pump (50) do not acted, while the air from the root vacuum pump set (30) directly bypasses through the backing pump (50) to be drained out.

13. The vacuum system having a condenser and a root vacuum pump set as claimed in claim 1, wherein liquid collecting and recycling tank unit (20) has an automatic double valve set up device (201) and a water level gauge (202) that is connected to a controller (203).

14. The vacuum system having a condenser and a root vacuum pump set as claimed in claim 1, wherein each root vacuum pump (40) has a casing (41) which has an inlet (411) and an outlet (412); an interior of the casing (41) is formed with a vacuum chamber (42) and two bearing rooms (43) at two sides of the vacuum chamber (42); the vacuum chamber (42) is connected and communicated to the inlet (411) and the outlet (412); a driving shaft (44) is installed within the casing (41) and penetrates through the vacuum chamber (42) and the two bearing rooms (43); one end of the driving shaft (44) passes out of a right wall (415) of the casing (41); a blade set (45) is installed within the vacuum chamber (42) and is installed on the driving shaft (44); the gas mixture is inputted from the inlet (411) to the vacuum chamber (42); by rotation of the blade set (45), the gas mixture is compressed and is outputted from the outlet (412); inner connection walls (413), (414) between the vacuum chamber (42) and the two bearing rooms (43) are installed with respective bearings (46) which are arranged to be around the driving shaft (44); as well as an opening of the right wall (415) of the casing (41) is formed with another bearing (46) around the driving shaft (44); the bearings (46) support the driving shaft (44); the bearings (46) completely seal spaces between the driving shaft (44) and the inner walls of the casing (41) so that the vacuum chamber (42) is completely isolated from the two bearing rooms (43); therefore, liquid out of the casing (41) and in the two bearing rooms (43) cannot permeate into the vacuum chamber (42); furthermore, the gas mixture in the vacuum chamber (42) cannot enter into the bearing rooms (43); therefore, in operation, interior of the vacuum chamber (42) of the root vacuum pump (40) only has original air and the gas mixture without any impurities; moreover, liquid within the bearing rooms (43) cannot drain out of the casing (41).

15. The vacuum system having a condenser and a root vacuum pump set as claimed in claim 14, wherein the root vacuum pump (40) has a structure which can suffer a great pressure difference; the great pressure means that the root vacuum pump (40) can operate under an inlet pressure of 5000 Pa to 30000 Pa in a whole day under a condition that the condenser is in a vacuum state and can suffer from a pressure difference larger than 5000 Pa.

16. The vacuum system having a condenser and a root vacuum pump set as claimed in claim 14, wherein the root vacuum pump (40) operates under temperatures larger than 130° C.
